(19) United States
(12) Patent Application Publication
(10) Pub. No.: US 2024/0326513 A1
(43) Pub. Date: Oct. 3, 2024

(54) SUSTAINABLE TIRE PRODUCED WITH HIGH RECYCLED/RENEWABLE RAW MATERIAL CONTENT

(71) Applicant: The Goodyear Tire & Rubber Company, Akron, OH (US)

(72) Inventors: Alexis Anne Kruth, Cuyahoga Falls, OH (US); Stacey Lynne Dean-Sioss, Broadview Heights, OH (US); Justin Yinket Che, Wadsworth, OH (US); Robert Vincent Dennis-Pelcher, Uniontown, OH (US); Adam Mark Baldan, Akron, OH (US); Douglas Andrew Till, Akron, OH (US); Bartosz Zielinski, Rollingen (LU); Kuo-Chih Hua, Richfield, OH (US); Bryce Alexander Butti, Avon, OH (US); James Joseph Golden, North Canton, OH (US); David Andrew Benko, Munroe Falls, OH (US)

(21) Appl. No.: 18/744,008

(22) Filed: Jun. 14, 2024

Related U.S. Application Data
(63) Continuation-in-part of application No. 18/067,048, filed on Dec. 16, 2022.

(51) Int. Cl. B60C 1/00

(52) U.S. Cl. CPC B60C 1/00

(57) ABSTRACT

It has been found that a pneumatic tire comprising non-ground contacting tire components each independently formed from a rubber composition comprising greater than 89% sustainable material content can be manufactured. In one scenario the pneumatic tire is comprised of bio-renewable organic materials, wherein the bio-based content of the organic materials is verifiable, and wherein radiocarbon ¹⁴C dating according to ASTM method D6866 shows the level of bio-based content of the organic materials to be at least 40%. In a preferred embodiment the tire has an RFID tag affixed to the innerliner of the tire, wherein the RFID tag designates the level of bio-renewable organic materials in the tire.

### CROSS-REFERENCE TO RELATED PATENT APPLICATIONS

This is a continuation-in-part of U.S. patent application Ser. No. 18/067,048, filed on Dec. 16, 2022. The teachings of U.S. patent application Ser. No. 18/067,048 are incorporated herein by reference in their entirety.

### FIELD OF THE INVENTION

The present exemplary embodiments relate to a vehicle tire containing a majority weight percent of raw materials made from processes or technologies that reduce carbon emissions and/or resource consumption, and/or recycled, renewable, bio-based, bio-derived and mass balanced raw materials. It finds particular application in conjunction with pneumatic consumer tires and will be described with particular reference thereto. However, it is to be appreciated that the present exemplary embodiments are also amenable to other like applications.

### BACKGROUND OF THE INVENTION

FIG. 1 is a schematic cross-section of a tire 10. Tire treads are typically of a cap/base construction, with the tread cap 12 designed to be ground-contacting and thus contain a lug/groove ground-contacting configuration, and with the tread base 14 underlying and supporting the tread cap and positioned between the tread cap and the tire carcass. Generally, the tread cap 12 and tread base 14 are a co-extruded component of the tire. The tread may be formed of one or more compounds.

A pneumatic tire 14 is further comprised of a generally toroidal-shaped carcass, two spaced beads 16 (steel beads coated with bead coat, not shown), at least one ply (comprising a belt 18, carcass, overlay 20 or breaker plies) extending from bead to bead, sidewalls 22 extending radially from and connecting said tread to said beads, an inner liner 24 that covers the inner surface of said pneumatic tire, and an optional barrier layer which is located between the inner liner and the ply. Radially outward from the bead wires are annular stiffeners/apexes 26, which extend between the optional barrier layer and the inner liner 24. Chafers 28, which provide support for the bead wires 16, are located axially outward from the apexes 26 where the ply layer 30 (i.e., a polyester fabric coated with plycoat) turns up about the bead wires 16. Gum strips 34 cover the ends of the ply 30. The belt and carcass plies are made up of wires coated with a rubber composition (hereinafter “wire coat” 36). Toeguards 38 seal the tire from air and pressure. Indeed, tires can be manufactured from as many as twenty (20) various rubber compositions each used in a different part of the tire.

There is an ongoing effort to develop sustainable solutions across all industries, including the tire and rubber industries. However, a sustainable tire must deliver a competitive performance before it can replace a well-performing predecessor. It is discovered herein that a pneumatic tire formed from greater than 85% and, more particularly, about 90% by weight sustainable content can provide improved or comparable performance to existing tires in the market. While conventional ingredients and/or tire parts are known, the sustainable combination disclosed herein has not been used before. There is a consumer desire to preferentially purchase products which contain recycled, renewable, bio-based, and bio-derived materials. In fact, consumers are even willing to pay a higher price for such products. For this reason, manufacturers and individuals are often willing to pay a premium price for products that are made with recycled and/or bio-renewable materials. For example, many plastic mailing envelopes have printed thereon a statement indicating that they are made with some minimum level of recycled material, such as 45% recycled material. Packaging containers for food products, such as ketchup bottles and beverage bottles, are sometimes also labeled in a manner that specifies the level of recycled and/or bio-renewable used in manufacturing the container.

By virtue of being environmentally conscious many consumers are willing to pay a higher price or are more likely to purchase products which are made with or packaged in recycled and/or bio-renewable materials. For example, recycled polyethylene terephthalate resin (PETE) normally sells for a higher selling price than does virgin PETE resin which is made from petroleum derived sources even though it does not provide any processing or performance benefits over the virgin plastic material. In any case, recycled or bio-derived materials typically sell for a premium price, particularly in cases where it can be verified that the material is actually bio-derived.

There is also currently a demand for tires which are made with sustainable raw materials. However, as previously explained there is a desire for such tires to be made without compromising performance characteristics, including durability, treadwear, wet traction, dry traction, or rolling resistance (for good fuel economy). It is, of course, desirable for recycled rubber, such as ground tire rubber, to be used in manufacturing new tires. Among other things recycling keeps worn-out tires from being simply discarded into landfills or from being burnt for their energy value. Some techniques for making recycled rubber more useful in manufacturing new tires are described in U.S. Pat. Nos. 9,574,069 B2, 9,598,564 B2, and 9,815,974 B2.

Recycling worn-out tires is not the answer to a totally sustainable system since the polymeric components from recycled tires may have originated from petroleum derived sources and are accordingly not sustainable. For the polymeric components of tires to be totally sustainable they must originate from bio-renewable sources, such as natural rubber or a synthetic rubber made with a bio-derived monomer, such as bio-isoprene as described in U.S. Pat. No. 8,420,759. It is additionally desirable for such tires made with bio-derived polymers to be recycled to prevent them from ultimately becoming solid waste in a landfill or from being burned which would lead to their contributing to an increase in the level of carbon dioxide in the atmosphere. In any case, there is a consumer demand for tires which are made with a high level of sustainable polymeric materials or preferable totally with sustainable polymeric materials. However, this need for such a sustainable tire has not yet been technically feasible and accordingly heretofore such tires have not been commercially available. Additionally, there is a further need for tires having a verifiable level of sustainable polymeric materials, such as the rubber components (the tread, the sidewall, and the carcass) and polymeric reinforcements in such tires (typically polyester or nylon reinforcements). In any case, there has been a long felt need for tires having a verifiable content of sustainable polymeric materials.

### SUMMARY OF THE INVENTION

One embodiment of the disclosure is directed to a sustainable tire formed from greater than about 85%, and, more preferably, about 90%, content from processes or technologies that reduce carbon emissions and/or resource consumption, and/or recycled, renewable, bio-based, bio-derived, and mass balanced raw materials relative to less than 20% in a conventional tire. In other words, the disclosed tire comprises over four times (4×) the percentage of sustainable content as compared to current tires. It is further discovered that such sustainable tire meets and/or exceeds the performance of the current consumer tire.

In one embodiment, the tire contains reinforcements characterized by greater than or equal to 65 percent by weight sustainable content. In one embodiment, the reinforcements are polyamide. Polyamide as a reinforcement material makes about 1.0% weight (lbs) per tire. By replacing conventional reinforcements with bio-derived polyamide 4.10 in a sustainable tire, the bio-derived polyamide 4.10 provides greater than 0.6% of the overall renewable content in a tire relative to a conventional tire absent polyamide. Alternatively, or complimenting the polyamide, recycled materials such as recycled polyester and/or recycled steel can be used.

In one embodiment, the tire comprises a liner characterized by greater than 35 percent by weight sustainable content as compared to a conventional liner at 0.5%. The liner makes from about 5.0% to about 6.0% weight (lbs) per tire. By replacing a conventional liner with the disclosed liner in a sustainable tire, the liner provides greater than 2.0% of the overall renewable content in the tire relative to less than 0.05% in a conventional tire.

In one embodiment, the tire comprises a belt wire characterized by greater than 85 percent by weight sustainable content as compared to a conventional belt wire at a minimum of 0%, depending on supplier. The belt wire makes from about 6.0% to about 7.0% weight (lbs) per tire. By replacing a conventional belt wire with the disclosed belt wire in a sustainable tire, the belt wire provides greater than 5.0% of the overall renewable content in the tire relative to less than 0.75% in a conventional tire.

In one embodiment, the tire comprises bead wire characterized by greater than 85 percent by weight sustainable content as compared to a conventional bead wire at a minimum of 0%, depending on supplier. The bead wire makes from about 5.0% to about 6.0% weight (lbs) per tire. By replacing a conventional bead wire with the disclosed bead wire in a sustainable tire, the bead wire provides greater than 4.5% of the overall renewable content in the tire relative to less than or equal to 0.50% in a conventional tire.

In one embodiment, the tire comprises gum strip characterized by greater than 89 percent by weight sustainable content as compared to a conventional gum strip at 27.5%. The gum strip makes from about 1.0% to about 2.0% weight (lbs) per tire. By replacing a conventional gum strip with the disclosed gum strip in a sustainable tire, the gum strip provides greater than 1.0% of the overall renewable content in the tire relative to less than 0.40% in a conventional tire.

In one embodiment, the tire comprises a wire coat characterized by greater than 90 percent by weight sustainable content as compared to a conventional wire coat at 29%. The wire coat makes from about 6.0% to about 7.0% weight (lbs) per tire. By replacing a conventional wire coat with the disclosed wire coat in a sustainable tire, the wire coat provides greater than 5.5% of the overall renewable content in the tire relative to less than 2.0% in a conventional tire.

In one embodiment, the tire comprises an apex characterized by greater than 90 percent by weight sustainable content as compared to a conventional apex at 0.9%. The apex makes from about 2.0% to about 3.0% weight (lbs) per tire. By replacing a conventional apex with the disclosed apex in a sustainable tire, the apex provides greater than 2.0% of the overall renewable content in the tire relative to less than 0.02% in a conventional tire.

In one embodiment, the tire comprises a bead coat characterized by greater than 91 percent by weight sustainable content as compared to a conventional bead coat at 1.6%. The bead coat makes from about 0.1% to about 0.5% weight (lbs) per tire. By replacing a conventional bead coat with the disclosed bead coat in a sustainable tire, the bead coat provides greater than 0.3% of the overall renewable content in the tire relative to none in a conventional tire.

In one embodiment, the tire comprises a base characterized by greater than 93 percent by weight sustainable content as compared to a conventional base at 41.3%. The base makes from about 4.0% to about 5.0% weight (lbs) per tire. By replacing a conventional base with the disclosed base in a sustainable tire, the base provides greater than 4.0% of the overall renewable content in the tire relative to less than 2.0% in a conventional tire.

In one embodiment, the tire comprises a plycoat characterized by greater than 93 percent by weight sustainable content as compared to a conventional plycoat at 51.1%. The plycoat makes from about 11.0% to about 12.0% weight (lbs) per tire. By replacing a conventional plycoat with the disclosed plycoat in a sustainable tire, the plycoat provides greater than 10.0% of the overall renewable content in the tire relative to less than 8.0% in a conventional tire.

In one embodiment, the tire comprises a tread characterized by greater than 93 percent by weight sustainable content as compared to a conventional tread at 2.5%. The tread makes from about 30.0% to 31.0% weight (lbs) per tire. By replacing a conventional tread with the disclosed tread in a sustainable tire, the tread provides greater than 28.0% of the overall renewable content in the tire relative to less than 0.75% in a conventional tire.

In one embodiment, the tire comprises a sidewall characterized by greater than 94 percent by weight sustainable content as compared to a conventional sidewall at 20.2%. The sidewall makes from about 9.0% to about 10.0% weight (lbs) per tire. By replacing a conventional sidewall with the disclosed sidewall in a sustainable tire, the sidewall provides greater than 9.0% of the overall renewable content in the tire relative to less than 3.0% in a conventional tire.

In one embodiment, the tire comprises an overlay characterized by greater than 94 percent by weight sustainable content as compared to a conventional overlay at 49.6%. The overlay makes up about 2% weight (lbs) per tire. By replacing a conventional overlay with the disclosed overlay in a sustainable tire, the overlay provides greater than 1.75% of the overall renewable content in the tire relative to less than 1.25% in a conventional tire.

In one embodiment, the tire comprises a toeguard characterized by greater than 95 percent by weight sustainable content as compared to a conventional to guard at 0.5%. The toeguard makes from about 3.0% to about 4% weight (lbs) per tire. By replacing a conventional toeguard with the disclosed toeguard in a sustainable tire, the toeguard provides greater than or equal to 3.0% of the overall renewable content in the tire relative to less than or equal to 0.02% in a conventional tire.

In one embodiment, the tire comprises a chafer characterized by greater than 95 percent by weight sustainable content as compared to a conventional chafer at 0.5%. The chafer makes from about 3.0% to about 4.0% weight (lbs) per tire. By replacing a conventional chafer with the disclosed chafer in a sustainable tire, the chafer provides greater than 3.25% of the overall renewable content in the tire relative to less than or equal to 0.02% in a conventional tire.

In one embodiment, the tire comprises a PET characterized by greater than 97 percent by weight sustainable content as compared to a conventional PET at 0%. The PET makes from about 4.0% to about 5.0% weight (lbs) per tire. By replacing a conventional PET with the disclosed PET in a sustainable tire, the PET provides greater than or equal to 4.0% of the overall renewable content in the tire relative to none in a conventional tire.

In one embodiment, each of the above parts are employed in the same tire. Non-limiting example raw sustainable materials incorporated in the sustainable tire comprise, among others, natural rubbers or mass-balanced diene-based polymers; fatty acids; bio-based resins such as terpene and/or rosin-based resins like rosin oil or rosin acid; bio-based coupling agents and/or systems such as bio-based silanes; vegetable triglyceride oil; fillers such as carbon black derived from bio-based or recycled feedstocks and/or rice husk ash silica; recycled materials such as zinc oxide, steel and/or polyester; and lignin-based antiozonant or antioxidant.

The present invention more specifically discloses a pneumatic tire which is comprised of a supporting carcass with an outer circumferential tread, two spaced beads, at least one ply extending from bead to bead, and sidewalls extending radially from and connecting said tread to said beads, wherein said tire is comprised of bio-renewable organic materials, wherein the bio-based content of the organic materials is verifiable, and wherein radiocarbon ¹⁴C dating according to ASTM method D6866 shows the level of bio-based content of the organic materials to be at least 40%. The level of bio-based content of the organic materials in such tires will normally be at least 50%, will typically be at least 60%, will more typically be at least 70%, will generally be at least 80%, will preferably be at least 85%, will more preferably be at least 90%, and will most preferably be at least 95%. In the very best scenario it is, of course, desirable for the organic materials in the tire to be verifiable as being totally bio-based (contain 100% bio-based renewable organic materials, such as rubbery polymers, polymeric reinforcements, carbon black, and rubber chemicals).

It is advantageous for such tires made with a verifiable level of bio-renewable organic materials to be conspicuously identified in a manner that delineates the level of such bio-renewable organic materials in the tire. This can be done by including such information on the sidewall of the tire or by molding some type of symbol, such as a leaf, conveying such information into the sidewall of the tire. However, it is greatly preferred for the tire to have a radio-frequency identification (RFID) tag which conveys that information embedded therein. This information is extremely beneficial in cases where the tire has completed its useful service life and is being recycled for use in making new rubber products.

The subject invention more specifically discloses a sustainable tire formed from tire parts comprising at least one each of a tread, plycoat, wirecoat, sidewall, chafer, toeguard, gumstrip, base, apex, overlay and beadcoat: wherein the tire parts are each formed from a diene rubber composition comprising a mass-balance synthetic polymer; wherein the diene rubber is present at greater than 35% by weight in the tire; and wherein the tire is formed from greater than about 85% by weight of content made from processes or technologies that reduce carbon emissions and/or resource consumption, and/or recycled, renewable, bio-based, bio-derived, and mass balance raw materials; wherein the bio-based content of the tire is verifiable, and wherein radiocarbon ¹⁴C dating according to ASTM method D6866 shows the tire to have a bio-based content of greater than 85%.

The present invention further reveals a pneumatic tire formed from a first rubber compound and a second rubber compound, each of the first and second rubber compound being independently incorporated in a non-ground contacting tire component, each of the first and second rubber compounds comprising, based on 100 phr of rubber polymer: at least one rubber polymer selected from a group consisting of mass balanced SBR; natural rubber; mass balanced polybutadiene; and mass balanced synthetic polyisoprene; a bio-based oil; an optional filler comprising sustainable carbon black or rice ash husk silica; wherein a total percent of renewable content in the first and second rubber compounds is greater than 80%.

The subject invention additionally discloses a sustainable tire formed from tire parts comprising at least one each of a tread, plycoat, wirecoat, sidewall, chafer, toeguard, gumstrip base, apex, overlay and beadcoat: wherein the tire parts are each formed from a diene rubber comprising natural rubber and/or mass-balance synthetic polymer; wherein the tire parts are produced from at least four different carbon blacks derived from methane, carbon dioxide, plant-based oil and end-of-life tire pyrolysis oil feedstocks; wherein the carbon blacks are present at greater than 15% by weight in the tire; and wherein the tire is formed from greater than about 85% by weight of content made from processes or technologies that reduce carbon emissions and/or resource consumption, and/or recycled, renewable, bio-based, bio-derived, and mass balance raw materials.

The present invention also reveals a sustainable tire comprising a toroidal-shaped carcass, two spaced, beads and sidewalls extending radially from and connecting a tread to the beads, the tire formed from rubber compositions comprising: at least a mass-balanced SSBR in the tread; at least a mass-balanced polybutadiene in the sidewall; at least a mass-balanced ESBR in the bead coat; wherein each of the tread, sidewall and bead coat are formed from greater than about 85% by weight of sustainable content made from processes or technologies that reduce carbon emissions and/or resource consumption, and/or recycled, renewable, bio-based, bio-derived, and mass balance raw materials.

### DESCRIPTION OF THE DRAWINGS

The invention will be described by way of example and with reference to the accompanying drawings in which:

FIG. 1 is a schematic cross-section diagram of a tire.

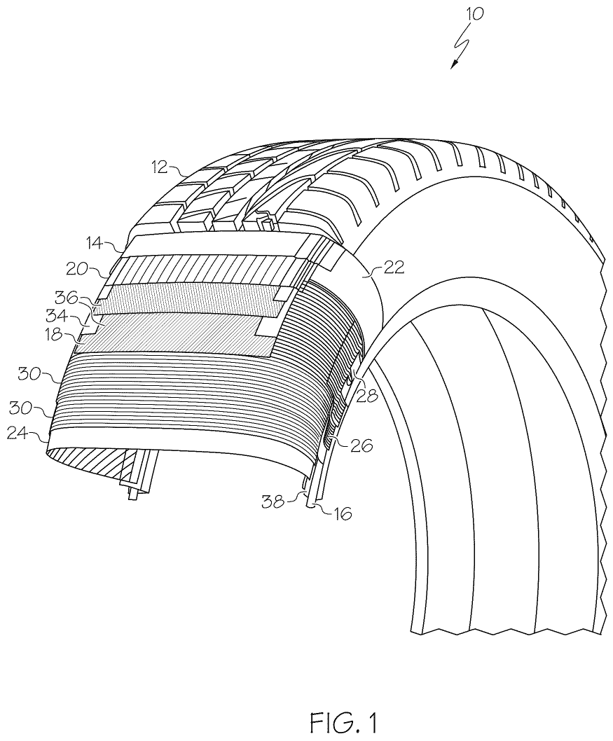

FIG. 2 is a table showing a summary of the combination of compounds outlined in examples 1 through 10 to form a tire with competitive performance.

FIG. 3 reports the results for the tire of FIG. 2.

### DETAILED DESCRIPTION OF THE INVENTION

The present disclosure relates to a vehicle tire containing a majority weight percent of sustainable content. The disclosure further relates to reinforcements and rubber compounds and, more particularly, to a combination of such, incorporated in the tire. In rubber tire compounds, each material and additive are combined with elastomers to impart specific properties in the resulting rubber. There is a desire to reduce, or altogether exclude, from tires the parts and/or materials that originate from nonrenewable sources. Disclosed herein is a tire being formed from a majority content of sustainable material and parts and that replicates or exceeds the performance of a conventional tire.

As used herein, the term “sustainable material” encompasses raw materials made from processes or technologies that reduce carbon emissions and/or resource consumption, and/or recycled, renewable, bio-based, bio-derived and mass balanced raw materials.

As used herein, the term “bio-based” or “bio-derived” refers to a circular material or a material derived from a renewable or sustainable resource or natural source, and may even include an industrial source when, for example, a byproduct or waste product is being captured and reused (recycled) to reduce or eliminate emissions and/or landfill waste that is harmful to the environment. One non-limiting example is the sequestration of carbon oxides for use as feedstock.

It partially, and more preferably fully, excludes radiocarbon and fossil carbon materials derived from petroleum, coal, or a natural gas source. Examples of resources from which the bio-based material can be derived include, but are not limited to, fresh (or from the fermentation) of biomass material, such as corn, vegetable oils, etc.

As used herein “mass balanced” means that at least a portion of the feedstock used to synthesize a material, such as a rubber polymer, resin or filler, is circular or bio-based. In practice, the production of carbon black or polymers can be certified as using mass-balanced principles. Carbon black can be synthesized using a percentage of circular tire pyrolysis oil (TPO) and traditional petroleum-based feedstock. Likewise, in the contemplated embodiment, at least 0.1%, and more preferably at least 1%, and most preferably at least 5%, of the feedstock to produce the polymer is circular or bio-based. In other words, a contemplated polymer or filler is produced from a mass balance of bio-based feedstock and traditional feedstock. One non-limiting example of a bio-based feedstock includes tall oil but may also include biomass, byproduct and waste products discussed supra. The term “mass-balanced” may also refer to carbon black and other byproducts obtained from the pyrolysis of scrap tires. A mass-balanced material is typically certified to the International Sustainability & Carbon Certification (ISCC) standard.

As used herein, the terms “compounded rubber”, “rubber compound” and “compound” refer to rubber compositions containing elastomers which have been compounded, or blended, with appropriate rubber compounding ingredients. The terms “rubber” and “elastomer” and “polymer” may be used interchangeably unless otherwise indicated. It is believed that such terms are well known to those having skill in the art.

As used herein, except where context requires otherwise, the term “comprise” and variations of the term, such as “comprising”, “comprises” and “comprised”, are not intended to exclude further additives, components, integers, or steps. As used herein, the words “from about” means approximately and can includes values±1 beyond the ones listed herein.

A key aspect of the disclosure is the percent weight content of sustainable content in the tire achieved using a combination of various renewable, bio-based, bio-derived, recycled, and/or mass balanced materials, and/or materials made from processes or technologies that reduce carbon emissions and/or resource consumption.

It is envisioned that the rubber compositions for these, inter alia, tire components may be formed from a combination of materials that create a final tire having between 50 weight percent (wt %) to 100 wt % sustainable content. In the contemplated embodiment, a combination of tire components is assembled to form greater than 50 wt % sustainable tire. The rubber compositions of individual tire components may each be independently formed from 0.01 to 100 wt % sustainable content but assembled in a tire to achieve a sustainable tire having at least 50 weight percent (wt %) and, more preferably, at least 60 wt % and, most preferably, at least 80 wt % of sustainable content measured relative to 100 wt % of a tire. In the working samples shown infra, one embodiment of the invention is a tire that achieves at least 88 wt % of sustainable content measured relative to 100 wt % of a tire.

Example materials that can be employed in the tire components can include, without limiting said materials to those disclosed below, natural rubber and synthetic polymers; fillers; plasticizers; vulcanizers; accelerators; and other additives.

### Polymers:

Rubber compositions used to form and/or coat the tire tread and/or parts may comprise at least one conjugated diene-based elastomer. In practice, various conjugated diene-based elastomers may be used for a rubber composition such as, for example, polymers and copolymers of at least one of isoprene and 1,3-butadiene and of styrene copolymerized with at least one of isoprene and 1,3-butadiene. Representative of such conjugated diene-based elastomers are, for example, comprised of at least one of cis 1,4-polyisoprene (natural and synthetic), cis 1,4-polybutadiene, styrene/butadiene copolymers (SBR), polybutadiene having a vinyl 1,2-content in a range of about 15 to about 90 percent, isoprene/butadiene copolymers, and styrene/isoprene/butadiene terpolymers.

In practice, the preferred rubber or elastomers are natural rubber, synthetic polyisoprene, polybutadiene and/or SBR. The synthetic rubber elastomers are preferably ISCC certified polymers. Examples of mass balanced elastomers can include SBR and polybutadiene in which circular or renewable feedstock are employed to synthesize the polymers. Non-limiting examples of polymers that can be employed in the disclosed tire can include any ISCC polymer, such as ISCC SBRs available as BUNA™ SB 1502 or SPRINTAN™ SLR 4602 by Synthos Group; and ISCC polybutadienes under the marks BUD 1208 or BUD 4001 by LG. In practice, at least two or more different mass balanced polymers may be used.

Preferably, a natural rubber or synthetic polyisoprene can be employed in the composition as the predominant polymer. Cis 1,4-polyisoprene natural rubber is well known to those having skill in the rubber art, although a Cis 1,4-polyisoprene synthetic can be used. However, as used herein, the term “natural rubber” refers to a latex derived from any natural source including Hevea (or rubber) trees and non-Hevea plants, such as, for example, guayule shrubs, dandelions, and sunflowers.

In some embodiments, only one polymer is used. Although, a blend of multiple polymers is contemplated.

In a contemplated embodiment, at least one rubber polymer is a styrene-butadiene rubber. Styrene/butadiene copolymers include those prepared by aqueous emulsion polymerization (ESBR) or organic solvent solution polymerization (SSBR). In the contemplated embodiment, an ESBR is contemplated, which typically has a bound styrene content in a range of about 9 to about 36 percent. However, embodiments are contemplated in which the ESBR has a bound styrene content of less than 30 percent.

An SSBR can also be employed in the rubber composition. SSBR can be non-functionalized or functionalized. Representative of functionalized elastomers are, for example, styrene/butadiene elastomers containing one or more functional groups comprised of
(A) amine functional group reactive with hydroxyl groups on precipitated silica,
(B) siloxy functional group, including end chain siloxy groups, reactive with hydroxyl groups on precipitated silica,
(C) combination of amine and siloxy functional groups reactive with hydroxyl groups on said precipitated silica,
(D) combination of thiol and siloxy (e.g. ethoxysilane) functional groups reactive with hydroxyl groups on the precipitated silica,
(E) combination of imine and siloxy functional groups reactive with hydroxyl groups on the precipitated silica,
(F) hydroxyl functional groups reactive with the precipitated silica.

In practice, a second rubber polymer can include polybutadiene. In one embodiment, the rubber composition comprises from about 1 phr to about 50 phr of at least one polybutadiene and, more preferably, from about 20 phr to about 40 phr of polybutadiene(s). In practice, it is envisioned that the cis 1,4-polybutadiene elastomer(s) may be a prepared cis 1,4-polybutadiene rubber which may be prepared, for example, by polymerization of 1,3-butadiene monomer in an organic solvent solution in the presence of a catalyst system comprised of a nickel compound. However, such 1,4-polybutadiene(s) can be prepared by organic solution lanthanide catalysis of cis 1,3-budadiene rubber instead.

It is further contemplated that, in certain embodiments, a secondary polymer may be a butyl type rubber, particularly copolymers of isobutylene with a minor content of diene hydrocarbon(s), such as, for example, isoprene and halogenated butyl rubber.

It is further contemplated that, in certain embodiments, a secondary polymer may comprise a halobutyl rubber comprising a blend consisting of chlorobutyl rubber, bromobutyl rubber and mixtures thereof.

### Oil

By desiring the rubber composition to contain fewer to no materials derived from petroleum, it is meant that the rubber composition will contain minimal, if any, petroleum-based plasticizers, including processing oil. For example, it is desired that the rubber composition be limited to less than 8 phr of petroleum-based processing oil and, more preferably, less than about 2 phr of rubber petroleum-based processing oil. In some embodiments, it is contemplated that all compounds in a tire exclude petroleum-based oil.

In one embodiment, the rubber composition may comprise up to about 50 phr of a bio-based rubber processing oil. In another embodiment, the rubber composition may comprise no less than a majority of bio-based oil among a combination of oils.

Processing oil may be included in the rubber composition as extending oil typically used to extend elastomers. Processing oil may also be included in the rubber composition by addition of the oil directly during rubber compounding. The processing oil used in the rubber composition may include both extending oil present in the elastomers and process oil added during compounding. A suitable bio-based oil is a vegetable triglyceride oil comprised of a combination of saturated and unsaturated esters where the unsaturated esters are comprised of a combination of at least one of oleic acid ester, linoleate acid ester and linoleate acid ester. The saturated esters may be comprised of, for example, and not intended to be limiting, at least one of stearic acid ester and palmitic acid ester.

In one embodiment, the vegetable triglyceride oil is comprised of at least one of soybean oil, sunflower oil, rapeseed oil, and canola oil, which are in the form of esters containing a certain degree of unsaturation. Other suitable examples of vegetable triglyceride oil include corn, coconut, cottonseed, olive, palm, peanut, and safflower oils. In practice, the oil includes at least one of soybean oil and sunflower oil.

In the case of soybean oil, for example, the above represented percent distribution, or combination, of the fatty acids for the glycerol tri-esters, namely the triglycerides, is represented as being an average value and may vary somewhat depending primarily on the type, or source of the soybean crop, and may also depend on the growing conditions of a particular soybean crop from which the soybean oil was obtained. There are also significant amounts of other saturated fatty acids typically present, though these usually do not exceed 20 percent of the soybean oil.

### Resin

In certain rubber compositions, a plasticizing, traction, tackifying and/or reinforcing resin is desired. Common resins are derived from petroleum. These types of resins include any hydrocarbon chemistry type resin (AMS, coumarone-indene, C5, C9, C5/C9, DCPD, DCPD/C9, others) & any modification thereof (phenol, C9, hydrogenation, recycled monomers, others). While these types of resins may be used in some compositions of the invention, the preferred embodiment instead employs a renewable biobased chemistry type resin and/or modification and mixture thereof. Examples of bio-based resins include terpene and rosin-based resins, such as rosin oil resin or gum resin.

Representative resins can also include coumarone type resins, including coumarone-indene resins and mixtures of coumarone resins, naphthenic oils, phenol resins, and rosins. Other suitable resins include phenol-terpene resins such as phenol-acetylene resins, phenol-formaldehyde resins, alkyl phenol-formaldehyde resins, terpene-phenol resins, polyterpene resins, and xylene-formaldehyde resins.

Terpene-phenol resins may be used. Terpene-phenol resins may be derived by copolymerization of phenolic monomers with terpenes such as limonenes, pinenes and delta-3-carene. In one embodiment, the resin can be an alpha pinene resin characterized by a softening point between 70° C. and 160° C.

In one embodiment, the resin is a resin derived from rosin and derivatives. Representative thereof are, for example, gum rosin (also referred to as rosin acid), wood rosin and tall oil rosin. Gum rosin, wood rosin and tall oil rosin have similar compositions, although the number of components of the rosins may vary. Such resins may be dimerized, polymerized or disproportionated. Such resins may be in the form of esters of rosin acids and polyols such as pentaerythritol or glycol. In one embodiment, the resin can be a gum rosin characterized by a softening point between 70° C. and 160° C.

In one embodiment, said resin may be partially or fully hydrogenated.

In one embodiment, the rubber composition can optionally comprise resin in up to about 50 phr.

### Filler

Rubber compositions typically comprise a filler material with common fillers including silica and/or carbon black. Common carbon black is derived from a petroleum feedstock. The tire of the invention uses rubber compositions formed using carbon black from a bio-based or recycled feedstock.

The ASTM-D6866 method to derive “bio-based” content is built on the same concepts as radiocarbon dating, but without use of the age equations. The method relies on determining a ratio of the amount of radiocarbon (¹⁴C) in an unknown sample to that of a modern reference standard. The ratio is reported as a percentage with the units “pMC” (percent modern carbon). If the material being analyzed is a mixture of present-day radiocarbon and fossil carbon (fossil carbon being derived from petroleum, coal or a natural gas source), then the obtained pMC value correlates directly to the amount of biomass material present in the sample.

The modern reference standard used in radiocarbon dating is a National Institute of Standards and Technology USA (NIST-USA) standard with a known radiocarbon content equivalent approximately to the year AD 1950, before excess radiocarbon was introduced into the atmosphere. AD 1950 represents zero (0) years old and 100 pMC. Present day (fresh) biomass materials, and materials derived therefrom, give a radiocarbon signature near 107.5.

The radiocarbon dating isotope (¹⁴C) has a nuclear half-life of 5730 years. Fossil carbon, depending upon its source, has very close to zero ¹⁴C content. By presuming that 107.5 pMC represents present day biomass materials and 0 pMC represents petroleum (fossil carbon) derivatives, the measured pMC value for a material will reflect the proportions of the two component types. Thus, a material derived 100% from present day vegetable oil would give a radiocarbon signature near 107.5 pMC. If that material was diluted with 50% petroleum derivatives, it would give a radiocarbon signature near 54 pMC.

A biomass content result is derived by assigning 100% equal to 107.5 pMC and 0% equal to 0 pMC. In this regard, a sample measuring 99 pMC will give an equivalent bio-based content result of 93%. This value is referred to as the “mean biobased result” and assumes all the components within the analyzed material were either present day living or fossil in origin.

The results provided by the ASTM D6866 method are the mean biobased result and encompass an absolute range of 6% (±3% on either side of the mean bio-based result) to account for variations in end-component radiocarbon signatures. It is presumed that all materials are present day or fossil in origin. The result is the amount of bio-based component “present” in the material—not the amount of bio-based material “used” in the manufacturing process.

In one embodiment, a tire component is formed from a rubber composition comprising a mass balanced or ISCC carbon black, such as a carbon black at least partially derived from a non-traditional feedstock, such as tall oil, methane, or end-of-life tire pyrolysis oil.

In one embodiment, a tire component is formed from a rubber composition comprising a carbon black filler having a greater than one percent (1%) modern carbon content as defined by ASTM D6866. The carbon black is produced from a bio-based feedstock prior to its addition to the rubber composition. In one embodiment, the carbon black is at least partially derived from a bio-based feedstock and, in a preferred embodiment, is completely devoid of fossil carbon.

In one embodiment, the bio-based or bio-recycled feedstock, from which the carbon black is derived, comprises at least one triglyceride vegetable oil, such as, for example, soybean oil, sunflower oil, canola oil, rapeseed oil, or combinations thereof. In one embodiment, the bio-based feedstock, from which the carbon black is derived, comprises at least one plant biomass, animal biomass and municipal waste biomass, or combinations thereof. In other words, the bio-based feedstock can be produced from a byproduct, such as methane, from the biomasses. Accordingly, carbon black that is formed from methane pyrolysis is characterized as bio-derived feedstock herein.

In one embodiment, the carbon black has at least 1% modern carbon content. In one embodiment, the carbon black has at least about 10% and, more preferably, at least about 25% and, most preferably, at least about 50% modern carbon content. In one embodiment, the carbon black has a biomass content result of at least about 1 pMC and, more preferably, at least about 54 pMC. In one embodiment, the carbon black may have a biomass content result of at least about 80 pMC.

Non-limiting examples of sustainable carbon black may include those produced by bio-oil, bio-diesel, and biologically derived hydrocarbons.

Generally, the bio-based carbon blacks are designed to meet the properties of the select grade of conventional carbon black.

Various combinations of carbon blacks (of differing particle sizes and/or other properties, including conventional, petroleum-carbon black) can also be employed in the disclosed rubber composition. Representative examples of rubber reinforcing carbon blacks are, for example, and not intended to be limiting, referenced in The Vanderbilt Rubber Handbook, 13^{th} edition, 1990, on Pages 417 and 418 with their ASTM designations. Such rubber reinforcing carbon blacks may have iodine absorptions ranging from, for example, 60 to 240 g/kg and DBP values ranging from 34 to 150 cc/100 g.

In one embodiment, the rubber composition comprises, based on 100 parts by weight (phr) of elastomer, from about 1 to about 125 phr of carbon black. In one embodiment, the rubber composition comprises no more than 125 phr of carbon black. In another embodiment, the rubber composition comprises no less than 1 phr of carbon black and, in certain embodiments, no less than 25 phr of carbon black.

Other embodiments are contemplated that employ a carbon-dioxide generated carbon reinforcing filler. Suitable carbon dioxide-generated carbon reinforcement may be produced using methods as described in U.S. Pat. Nos. 8,679,444; 10,500,582; and U.S. Ser. No. 17/109,262—the contents of which are each incorporated in their entirety herein.

Other embodiments are contemplated in which the carbon black is used in combination with another filler, such as silica.

In one embodiment, the precipitated silica is comprised of:
(A) a precipitated silica derived from inorganic sand (silicon dioxide-based sand), or
(B) a precipitated silica derived from rice husks (silicon dioxide containing rice husks), or
(C) a combination of both.

In one embodiment the precipitated silica is derived from naturally occurring inorganic sand (e.g. SiO₂, silicon dioxide, which may contain a trace mineral content). The inorganic sand is typically treated with a strong base such as, for example, sodium hydroxide, to form an aqueous silicate solution (e.g. sodium silicate). A synthetic precipitated silica is formed therefrom by controlled treatment of the silicate with an acid (e.g. a mineral acid and/or acidifying gas such as, for example, carbon dioxide). Sometimes an electrolyte (e.g. sodium sulfate) may be present to promote formation of precipitated silica particles. The recovered precipitated silica is an amorphous precipitated silica.

In a preferred embodiment, the precipitated silica is a rice husk derived precipitated silica. Such precipitated silica is from derived rice plant husks (e.g. burnt ashes from rice husks) which contain SiO₂, silicon dioxide, and which may contain trace minerals from the soil in which the rice has been planted). In a similar methodology, the rice husks (e.g. rice husk ash) is typically treated with a strong base such as, for example, sodium hydroxide, to form an aqueous silicate solution (e.g. sodium silicate) following which a synthetic precipitated silica is formed therefrom by controlled treatment of the silicate with an acid (e.g. a mineral acid and/or acidifying gas such as, for example, carbon dioxide) in which an electrolyte (e.g. sodium sulfate) may be present to promote formation of precipitated silica particles derived from rice husks. The recovered precipitated silica is an amorphous precipitated silica. For Example, see U.S. Patent Application Serial No. 2003/0096900. In practice, the rubber composition comprises between 25 and 100 weight percent of rice husk ash silica and, more preferably, between 50 and 80 weight percent of rice husk ash silica.

The precipitated silica, whether derived from the aforesaid silicon dioxide or rice husks, may, for example, have a BET surface area, as measured using nitrogen gas, in the range of, for example, about 40 to about 600, and more usually in a range of about 50 to about 300 square meters per gram. The BET method of measuring surface area might be described, for example, in the Journal of the American Chemical Society, Volume 60, as well as ASTM D3037.

For embodiments in which the filler comprises both carbon black and silica, the carbon black may be present at a majority content level and the silica may be present at the minority content level. However, the reverse is contemplated for some tire components, such as a tread.

### Coupling Agent

Representative of silica coupler for use with the silica are:
(A) bis(3-trialkoxysilylalkyl) polysulfide containing an average in range of from about 2 to about 4, alternatively from about 2 to about 2.6 or from about 3.2 to about 3.8, sulfur atoms in its connecting bridge, or
(B) an alkoxyorganomercaptosilane, or
(C) their combination.

Representative of such bis(3-trialkoxysilylalkyl) polysulfide is comprised of bis(3-triethoxysilylpropyl) polysulfide.

The silica, discussed supra, is desirably added to the rubber composition in combination with the bis(3-triethoxysilylpropyl) polysulfide for reaction thereof in situ within the rubber composition.

In one embodiment, the composition comprises silane coupling agent at a level commensurate with the amount of silica filler.

In a preferred embodiment, the coupling agent is a bio-based coupling agent or a bio-based silane coupling agent. One non-limiting example bio-based coupling agent is bis(triethoxysilylpropyl)polysulfide (TESPT).

### Processing Aid-Fatty Acid/Derivatives

Another aspect of the present disclosure is the optional addition of a bio-derived processing aid for the rubber composition in some embodiments. Generally, from about 0.5 to about 5 phr and, more preferably, from about 1 to about 3 phr of processing aid may be comprised in the composition. In a preferred embodiment, the processing aid can be a bio-based fatty acid, for example, stearic acid or tall oil fatty acid (TOFA), such as SYLFAT line of TOFAs from Kraton® or others.

In another embodiment, the processing aid can be a bio-based fatty acid, a fatty acid derivative and/or a blend of bio-based fatty acid derivative(s). Such a blend can have a softening point (Tg) in the range of from about 105° C. to about 120° C. In a contemplated embodiment, the processing aid can be obtained as ZB 49 from Struktol® or others. In some embodiments, the processing aid can be used to promote coupling between a coupling agent, silica filler and/or moieties on the polymer to the network between the polymers.

It is readily understood by those having skill in the art that the rubber composition would be compounded by methods generally known in the rubber compounding art, such as mixing the various sulfur-vulcanizable constituent rubbers with various commonly used additive materials such as, for example, sulfur donors, curing aids, such as activators, accelerators and retarders and processing additives, fillers, pigments, fatty acid, zinc oxide, waxes, antioxidants and antiozonants and peptizing agents. As known to those skilled in the art, depending on the intended use of the sulfur vulcanizable and sulfur-vulcanized material (rubbers), the additives mentioned above are selected and commonly used in conventional amounts.

Representative examples of sulfur donors include elemental sulfur (free sulfur), an amine disulfide, polymeric polysulfide and sulfur olefin adducts. Preferably, the sulfur-vulcanizing agent is elemental sulfur. The sulfur-vulcanizing agent may be used in an amount ranging from 0.5 to 8 phr, with a range of from 1 to 6 phr being preferred. Typical amounts of antioxidants comprise about 0.5 to about 5 phr. Representative antioxidants may be, for example, polymerized trimethyl dihydroquinoline, mixture of aryl-p-phenylene diamines, and others, such as, for example, those disclosed in The Vanderbilt Rubber Handbook (1978), pages 344 through 346. In the preferred embodiment, the antioxidant is a lignin-based antioxidant. Typical amounts of antiozonants comprise about 1 to 5 phr. A non-limiting representative antiozonant can be, for example, a lignin-based antioxidant. Although N-(1,3 dimethyl butyl)-n′-phenyl-p-phenylenediamine is also contemplated. Typical amounts of fatty acids, if used, which can include stearic acid as an example, can comprise about 0.5 to about 5 phr. Typical amounts of zinc oxide comprise about 1 to about 5 phr. In a preferred embodiment, the zinc oxide is derived from recycled content. Typical amounts of waxes comprise about 1 to about 5 phr. Often microcrystalline waxes are used, but refined paraffin waxes or combinations of both can be used. Typical amounts of peptizers comprise about 0.1 to about 1 phr. Typical peptizers may be, for example, pentachlorothiophenol and dibenzamidodiphenyl disulfide.

Accelerators are used to control the time and/or temperature required for vulcanization and to improve the properties of the vulcanizate. In one embodiment, a single accelerator system may be used, i.e., primary accelerator. The primary accelerator(s) may be used in total amounts ranging from about 0.2 to about 3, preferably about 1 to about 2.5 phr. In another embodiment, combinations of a primary and a secondary accelerator might be used with the secondary accelerator being used in total amounts ranging from about 0.2 to about 3, preferably about 1 to about 2.5 phr., in order to activate and to improve the properties of the vulcanizate. Combinations of these accelerators might be expected to produce a synergistic effect on the final properties and are somewhat better than those produced by use of either accelerator alone. In addition, delayed action accelerators may be used which are not affected by normal processing temperatures but produce a satisfactory cure at ordinary vulcanization temperatures. Vulcanization retarders might also be used. A nonlimiting example of a retarder can be N-cyclohexylthiophthalimide (CTP). Suitable types of accelerators that may be used in the present invention are amines, disulfides, guanidines, thioureas, thiazoles, thiurams, sulfenamides, dithiocarbamates and xanthates. Preferably, the primary accelerator is a sulfenamide, such as, for example, N-cyclohexyl-2-benzothiazolesulfenamide (CBS), N-tert-buty-benzothiazole-2-sulphenamide (TBBS), or N,N-Dicyclohexyl-2-benzothiazolesulfenamide (DCBS). If a second accelerator is used, the secondary accelerator is preferably a guanidine (such as diphenyl guanidine (DPG)), dithiocarbamate (such as zinc dimethyl di-thiocarbamate or zinc dibenzyl di-thiocarbamate) or thiuram compound.

The mixing of the rubber composition can be accomplished by methods known to those having skill in the rubber mixing art. For example, the ingredients are typically mixed in at least two stages, namely, at least one non-productive stage followed by a productive mix stage. The final curatives including sulfur-vulcanizing agents are typically mixed in the final stage which is conventionally called the “productive” mix stage in which the mixing typically occurs at a temperature, or ultimate temperature, lower than the mix temperature(s) than the preceding non-productive mix stage(s). The terms “non-productive” and “productive” mix stages are well known to those having skill in the rubber mixing art. The rubber composition may be subjected to a thermomechanical mixing step. The thermomechanical mixing step generally comprises a mechanical working in a mixer or extruder for a period of time suitable in order to produce a rubber temperature between 140° C. and 190° C. The appropriate duration of the thermomechanical working varies as a function of the operating conditions, and the volume and nature of the components. For example, the thermomechanical working may be from 1 to 20 minutes.

Vulcanization of a pneumatic tire of the present invention is generally carried out at conventional temperatures ranging from about 100° C. to 200° C. Preferably, the vulcanization is conducted at temperatures ranging from about 110° C. to 180° C. Any of the usual vulcanization processes may be used such as heating in a press or mold, heating with superheated steam or hot air. Such tires can be built, shaped, molded and cured by various methods which are known and will be readily apparent to those having skill in such art.

The disclosure contemplates a tire component formed from such method. Similarly, the tire component may be incorporated in a tire. The tire component can be ground contacting or non-ground contacting. The tire can be pneumatic or non-pneumatic. In one embodiment, the tire component can be a coating compound, such as a ply coat, wire coat, bead coat or gum strip. The tire component can be an apex, an inline overlay or innerliner or tread base. Generally, as discussed supra, the tire component is non-ground contacting.

The tire of the present disclosure may be a race tire, passenger tire, aircraft tire, agricultural, earthmover, off-the-road, truck (commercial or passenger) tire, and the like. Preferably, the tire is a passenger or truck tire. The tire may also be a radial or bias, with a radial being preferred.

The rubber composition itself, depending largely upon the selection and levels of renewable materials, may also be useful in a tire tread, sidewall, reinforcement, or other tire components, but is also amenable to other applications including rubber tracks, conveyor belts or other industrial product applications, such as windshield wiper blades, brake diaphragms, washers, seals, gaskets, hoses, conveyor belts, power transmission belts, shoe soles, shoe foxing and floor mats for buildings or automotive applications.

In a preferred embodiment the pneumatic tires of this invention are comprised of a supporting carcass with an outer circumferential tread, two spaced beads, at least one ply extending from bead to bead, and sidewalls extending radially from and connecting said tread to said beads, wherein said tire is comprised of bio-renewable organic materials, wherein the bio-based or bio-derived content of the organic materials is verifiable, and wherein radiocarbon ¹⁴C dating according to ASTM method D6866 shows the level of bio-based or bio-derived content of the organic materials to be at least 40%. The level of bio-based or bio-derived content of the organic materials in such tires will normally be at least 50%, will typically be at least 60%, will more typically be at least 70%, will generally be at least 80%, will preferably be at least 85%, will more preferably be at least 90%, and will most preferably be at least 95%. In the very best scenario it is, of course, desirable for the organic materials in the tire to be verifiable as being totally bio-based (contain 100% bio-based renewable organic materials).

The organic materials in the tire include the rubbery polymers, polymeric reinforcements, extending oils, processing oils, carbon black, and rubber chemicals in the tire. Accordingly, it is desirable for the all of these components of the tire to be comprised to the greatest extent possible with bio-based materials. For instance, it is desirable for the rubber components of the tire to be made of a natural rubber or a synthetic rubber derived from bio-renewable monomers, such a one or more of the bio-isoprene containing monomers described in U.S. Pat. No. 8,420,759, such as synthetic polyisoprene rubber made with bio-isoprene. The teachings of U.S. Pat. No. 8,420,759 are incorporated by reference herein for the purpose of describing such bio-renewable rubbers and their synthesis. It is also desirable for the extending oils utilized in making the rubber and the processing oils employed in making the rubber formulations used in the tire to be bio-renewable. For example, vegetable oils, such as soybean oil and corn oil can be beneficially utilized as extender oils or processing oils. In fact, it has been determined that oil extending styrene-butadiene rubber with soybean oil can lead to exceptional rubber properties as described in U.S. Pat. No. 10,435,545 B2. The teachings of U.S. Pat. No. 10,435,545 B2 are incorporated by reference herein for the purpose of describing such soybean oil extended rubbers. As previously explained, it is also highly desirable to utilize bio-renewable carbon black in the tire of this invention.

In one embodiment of this invention the polymeric materials will include rubbery polymers having a level of bio-based content of at least 45%. Such rubbery polymers will normally have a bio-based content of at least 50%, typically be at least 60%, more typically be at least 70%, generally be at least 80%, preferably be at least 85%, more preferably be at least 90%, and most preferably be at least 95%. The carbon black utilized in the tires of this invention will normally have a bio-based content of at least 50%, typically be at least 60%, more typically be at least 70%, generally be at least 80%, preferably be at least 85%, more preferably be at least 90%, and most preferably be at least 95%. It is highly preferable for the carbon black to have a bio-based content of 99% or even 100%.

In one embodiment of this invention the tire will include a marking or preferably a radio-frequency identification (RFID) tag which designates the level of bio-renewable organic materials in the tire. Such a designation will facilitate recycling of the tire after it has served its useful service life. For instance, this information would be extremely useful in maintaining the verifiability of the level of bio-renewable organic materials of new tire made with recycled organic materials from such tires. This is because including recycled rubber from tires which were originally made with petroleum derived sources would ultimately destroy the verifiability of new tires made with such recycled material. In other words, for purposes of verifiability it is extremely important to know the level of bio-renewable organic material in tires that are being recycled into new tires.

The RFID tag will also preferably include information regarding the identity and levels of rubbers included in the tire in addition to providing information regarding the level or minimum level of bio-renewable organic materials in the tire. For example, this information might include the monomeric content of the rubbers included in the tire as well as a characterization of the rubber or rubbers, such as number average molecular weight, weight average molecular weight, polydispersity, microstructure (cis-microstructure content, trans-microstructure content, vinyl-content, and/or glass transition temperature). The RFID tag is a very small radio transponder and will normally be a passive tag since passive tags are less expensive, smaller, and are capable of providing all of the information that is needed in the subject application. Such passive tags are powered by energy from the interrogating radio waves of a RFID reader and accordingly do not require batteries. When triggered by an electromagnetic interrogation pulse from a RFID reader the tag transmits a digital identification number conveying the tire information back to the RFID reader. For example, the digital identification number might correspond to a tire having a bio-derived content of organic materials of at least 85%.

Such passive RFID tags are comprised of three critical components which include a microchip, an antenna, and a substrate. The microchip (the IC) includes an integrated circuit which provides memory to store data and processes information and modulates and demodulates radio-frequency signals. The antenna collect power from the radio waves sent by the interrogator, receives the signals sent from the interrogator, and reflects the signal back to the interrogator. The antenna is designed for a specific frequency of operation and is tuned for use in conjunction with the tire to which it will be affixed. The antenna will typically be comprised of a thin strip of copper, aluminum, or silver which is affixed to the substrate which holds the components of the RFID tag together. The substrate will be typically be made from flexible material having a thickness of which is within the range of 100 nm to 200 nm and which is capable of dissipating static buildup, such as polyethylene terephthalate, paper, or natural rubber which compounded with at least about 5 phr of natural rubber. In any case, the substrate must be made of a material which can withstand the environmental conditions through which the tag may encounter within the lifecycle of the tire to which it is attached.

In one embodiment of this invention one side of the substrate is coated with an adhesive for adhering the RFID tag to the inside of a tire cavity, such as to the innerliner of the tire wherein the innerliner which is disposed inwardly from the supporting carcass of the tire. For instance, the RFID tag can be affixed to the innerliner of the tire in the sidewall area of the tire. Optionally, a protective overlay which is comprised of natural rubber or a synthetic rubber can be built over the RFID tag to further protect it from environmental damage. In such a case the protective overlay will be positioned inwardly from the RFID tag so as to sandwich the RFID tag between the innerliner and the protective overlay.

Tires which are identified as having a specified high level of bio-renewable organic material content with a RFID tag can then be recycled into new tires which also have a known level of bio-renewable organic material content. In one embodiment of this invention tires can be sorted and accepted or rejected for recycling into new tires based on their bio-renewable organic content level or other criteria set by the tire manufacturer. This sorting can be done either manually or automatically. In any case, it allows for the rubber component of worn-out tires to be recycled into new tires having an acceptable level of bio-renewable organic material content.

Systems for automatically sorting tires with such RFID tags affixed thereto saves a considerable amount of labor and is accordingly extremely cost effective. Such automatic sorting systems also reduce the possibility of error in identifying the level of bio-renewable organic content in worn-out tires. Such automatic sorting systems include an interrogator which identifies the level of modern carbon in the used tire. Typically used tires will be conveyed past the interrogator on a conveyor belt on some other type of conveyance system, such as a downward sloping series of rollers. Tires will then be sorted and separated based on their bio-renewable organic material content and optionally other criteria relating to the identity and/or content of rubber formulations therein. Tires which do not contain such RFID tags will normally be separated into a pool of tires having an unknown content of bio-renewable organic material. Accordingly, such tires will not normally be used in making new tires having a verifiable level of bio-renewable material unless the level of bio-renewable organic material in the tire is confirmed by some other means, such as by labeling or a symbol on the sidewall of the tire.

Tires will typically be automatically separated into different recycle streams based upon the information revealed by the RFID tag and optionally information provided by labeling or symbols of the sidewall of the tire. For example, the tires can be diverted into two or more recycle streams and conveyed to separate recycle fed streams. This is typically carried out using a channeling device in conjunction with conveyor belts. In any event, such a system for automatically sorting used tires is normally comprised of a used tire fed line, an interrogator, a separator, a diverter, and at least two recycle conveyance lines. This invention accordingly reveals a system of separating used or flawed tires based upon their content of bio-renewable organic materials which comprises passing tires having RFID tags affixed thereto which depicts the level of bio-renewable organic material in the tires through a separator system which is comprised of a tire fed line, an interrogator, a separator, a diverter, and at least two recycle conveyance lines.

The following examples are presented for the purposes of illustrating and not limiting the present invention. All parts are parts by weight unless specifically identified otherwise.

### EXAMPLES

In these examples, the effects of the disclosed combinations of renewable content on the performance of a rubber compound are illustrated. Rubber compositions were mixed in a multi-step mixing procedure following the recipes in Tables 1-10.

The controls and experimental samples were formed using a single polymer or blends of polybutadiene BR, emulsion polymerized styrene butadiene copolymer ESBR, natural rubber, and synthetic polyisoprene with one or more additive materials including oil (soybean), a carbon black filler, a bio-based resin, a bio-based silane coupling agent, waxes, antiozonant, a lignin-based antioxidant, a blend of bio-based fatty acid derivatives, and a recycled zinc oxide. Standard curing techniques were also used.

Viscoelastic properties (G′ and tan delta TD) were measured using an ARES Rotational Rheometer rubber analysis instrument which is an instrument for determining various viscoelastic properties of rubber samples, including their storage moduli (G′) over a range of in torsion as measured at 3% strain and a frequency of 10 Hz. Generally, a higher G at 30° C. indicates a better handling performance for a tire containing the given compound. A lower G′ at −20° C. generally indicates improved snow performance of a tire containing the compound. Tan delta is given as measured at 10% strain and a frequency of 10 Hz at 0° C. and 30° C. Generally, a lower tan delta at 30° C. indicates a lower rolling resistance in a tire containing the given compound, while a higher tan delta at 0° C. indicates improved wet traction in a tire containing the given compound.

Cure properties were determined using a Monsanto oscillating disc rheometer (MDR) which was operated at a temperature of 150° C. and at a frequency of 11 hertz. A description of oscillating disc rheometers can be found in The Vanderbilt Rubber Handbook edited by Robert O. Ohm (Norwalk, Conn., R. T. Vanderbilt Company, Inc., 1990), Pages 554 through 557. The use of this cure meter and standardized values read from the curve are specified in ASTM D-2084. A typical cure curve obtained on an oscillating disc rheometer is shown on Page 555 of the 1990 edition of The Vanderbilt Rubber Handbook.

Other viscoelastic properties were determined using a Flexsys Rubber Process Analyzer (RPA) 2000. A description of the RPA 2000, its capability, sample preparation, tests and subtests can be found in these references. H A Pawlowski and J S Dick, Rubber World, June 1992; J S Dick and H A Pawlowski, Rubber World, January 1997; and J S Dick and J A Pawlowski, Rubber & Plastics News, Apr. 26 and May 10, 1993.

Rebound is a measure of hysteresis of the compound when subject to loading, as measured by ASTM D1054. Generally, the higher the measured rebound at 60° C. and 100° C., the lower the rolling resistance in a tire containing the given compound.

Abrasion was determined as Grosch abrasion rate as run on a LAT-100 Abrader and measured in terms of mg/km of rubber abraded away. The test rubber sample is placed at a slip angle under constant load (Newtons) as it traverses a given distance on a rotating abrasive disk (disk from HB Schleifmittel GmbH). A high abrasion severity test may be run, for example, at a load of 70 newtons, 12° slip angle, disk speed of 20 km/hr for a distance of 250 meters. Grosch abrasion values were not compared between study sets. Additional abrasion measurements were determined using relative volume loss tested using DIN abrasion relative to a standard according to ASTM D5693 at a load of 10 N.

Tear strength was determined following ASTM D4393 except that a sample width of 2.5 cm is used and a clear Mylar 15 plastic film window of a 5 mm width is inserted between the two test samples. It is an interfacial adhesion measurement (pulling force expressed in N/mm units) between two layers of the same tested compound which have been co-cured together with the Mylar film window therebetween. The purpose of the Mylar film window is to delimit the width of the pealed area.

Adhesion was determined following the Standard Bead Wire Adhesion Test, according to ASTM D1871 Method 1.

Ozone testing was done using the ASTM D1149 procedure using rectangular test specimens (1 inch wide×3.75 inch length). The rubber samples are clamped into frames and looped until the ends meet. After a conditioning period, specimens are placed in the ozone test chamber set at 40° C. and 0.50 PPHM ozone concentration for 48 hours before evaluation.

### Example 1

The Control C1 is a conventional bead coat compound. Sample E1 replaces the naphthenic oil with equal parts soybean oil; made a small adjustment to the cure package; replaces conventional zinc oxide with a zinc oxide with recycled content; replaces conventional carbon black from a carbon black derived from plant-based oil; and replaces the conventional silica with equal parts rice husk ash silica, with all other ingredients being the same.

The rubber compounds were then cured and tested for various properties including, inter alia, rebound, stiffness, cure state, and stress/strain (MTE) properties, etc.

The basic formulations are shown in the following Table 1, which is presented in parts per 100 parts by weight of elastomer (phr). Results of the tests are also reported in Table 1, with the results of the Control rubber composition being normalized to values of 100 and the results for the Experimental Sample being related to the normalized value.

TABLE 1

Samples

| | Control | Exp'l |
|---|---|---|
| | C1 | E1 |
| ESBR | 100 | 0 |
| Mass balance ESBR | 0 | 100 |
| Naphthenic oil | 21 | 0 |
| Soybean oil | 0 | 21 |
| Conventional silica | 7 | 0 |
| Rice husk ash silica | 0 | 7 |
| Conventional carbon black | 115 | 0 |
| Carbon black from plant- | 0 | 115 |
| based oil | | |
| Conventional ZnO | 4.5 | 0 |
| Recycled ZnO | 0 | 4.5 |
| Cure Package | | Increase |
| Viscosity RPA at 0.83 Hz, 100° C. | | |
| G′ 15% (MPa) | 100 | 106 |
| Cure State | | |
| Delta Torque (dNm) | 100 | 102 |
| T90 (min) | 100 | 83 |
| Stiffness | | |
| RPA G′ 1% (MPa) | 100 | 97 |
| RPA G′ 50% (MPa) | 100 | 110 |
| MTE Properties | | |
| 100% Modulus (MPa) | 100 | 105 |
| Tensile strength (MPa) | 100 | 95 |
| Elongation at break (%) | 100 | 81 |
| Hardness | | |
| Shore A 3S at 23° C. | 100 | 100 |
| Shore A 3S at 100° C. | 100 | 100 |
| Adhesion | | |
| SBAT Adhesion max force | 100 | 89 |
| (N) | | |
| Rebound | | |
| 23° C. (%) | 100 | 102 |
| 100° C. (%) | 100 | 107 |

A tire of the disclosed invention can employ a bead having a bead coating (or bead filler) rubber composition comprising 100 phr of a mass-balanced styrene butadiene rubber and from 5 phr to 30 phr of vegetable oil such as soybean oil and up to 20 phr of rice ash husk silica in the present embodiment. Moreover, a bead rubber composition may further comprise a plant-oil based carbon black, and curatives and vulcanization accelerators such as a recycled zinc oxide.

### Example 2

Experimental Sample E2 is shown in Table 2. The Control C2 is a conventional apex compound. Sample E2 is a full natural rubber compound that replaces the naphthenic oil with soybean oil and increases the cure package. Sample E2 adjusted levels of resin and carbon black to improve reinforcement. Sample E2 uses recycled zinc oxide in place of conventional zinc oxide, with all other ingredients being the same.

The rubber compounds were then cured and tested for various properties including, inter alia, rebound, stiffness, cure state, and stress/strain (MTE) properties, etc.

The basic formulations are shown in the following Table 2, which is presented in parts per 100 parts by weight of elastomer (phr). Results of the tests are also reported in Table 2, with the results of the Control rubber composition being normalized to values of 100 and the results for the Experimental Sample being related to the normalized value.

TABLE 2

| | Samples | |
|---|---|---|
| | Control | Experimental |
| | C2 | E2 |
| Natural rubber | 0 | 100 |
| Synthetic polyisoprene | 60 | 0 |
| ESBR | 40 | 0 |
| Conventional carbon blacks | 92 | 0 |
| Carbon black derived from plant-based oil | 0 | 95 |
| Naphthenic oil | 6.5 | 0 |
| Soybean oil | 0 | 9 |
| Resin¹ | 3 | 7.50 |
| Conventional ZnO | 3 | 0 |
| Recycled ZnO | 0 | 5 |
| Cure package | | Increase |
| Viscosity RPA at 0.83 Hz, 100° C. | | |
| G′, 15% (MPa) | 100 | 112 |
| Cure State | | |
| Delta Torque (dNm) | 100 | 109 |
| T90 (min) | 100 | 91 |
| Stiffness | | |
| RPA G′ 1% (MPa) | 100 | 124 |
| RPA G′ 15% (MPa) | 100 | 107 |
| MTE Properties | | |
| 100% Modulus (MPa) | 100 | 140 |
| Tensile strength (MPa) | 100 | 114 |
| Elongation at break (%) | 100 | 82 |
| Tear 100° C. (N) | 100 | 81 |
| Rebound | | |
| Rebound at 23° C. (%) | 100 | 104 |
| Rebound at 100° C. (%) | 100 | 98 |
| Shore A Hardness | | |
| at 23° C. (%) | 100 | 102 |
| at 100° C. (%) | 100 | 103 |

¹Phenol formaldehyde reactive type resin

The apexes of the disclosed tire can employ an apex rubber composition comprising 100 phr of natural rubber and a vegetable oil (such as soybean or rapeseed oil) within a range of 1 phr to 15 phr. Moreover, the composition comprises a phenol formaldehyde reactive type resin within a range of 5 phr to 20 phr, a carbon black derived from plant-based oil within the range of 80 and 100 phr, and recycled zinc oxide in the range of 2 to 7 phr.

### Example 3

Experimental Sample E3 is shown in Table 3. The Control C3 is a conventional tread base compound. Sample E3 replaces the conventional polybutadiene with a mass balanced polybutadiene. Sample E3 also replaces naphthenic oil with equal parts soybean oil; makes small adjustments to the cure package; replaces a conventional antioxidant with an antioxidant derived from lignin; replaces conventional zinc oxide with zinc oxide with recycled content; and replaces the conventional carbon black with a carbon black derived from ELT pyrolysis oil, with all other ingredients being the same as C3

The rubber compounds were then cured and tested for various properties including, inter alia, rebound, stiffness, cure state, and stress/strain (MTE) properties, etc.

The basic formulations are shown in the following Table 3, which is presented in parts per 100 parts by weight of elastomer (phr). Results of the tests are also reported in Table 3, with the results of the Control rubber composition being normalized to values of 100 and the results for the Experimental Sample being related to the normalized value.

TABLE 3

Samples

| | Control | Experimental |
|---|---|---|
| | C3 | E3 |
| Polybutadiene | 35 | 0 |
| Mass balance BR | 0 | 35 |
| Natural rubber | 65 | 65 |
| Conventional carbon black | 42 | 0 |
| Carbon black from ELT pyrolysis oil | 0 | 47 |
| Naphthenic oil | 6 | 0 |
| Soybean oil | 0 | 6 |
| Conventional antioxidant | 1 | 0 |
| Lignin based antioxidant | 0 | 1 |
| Conventional ZnO | 2.5 | 0 |
| Recycled ZnO | 0 | 2.5 |
| Cure package | | Increase |
| Viscosity RPA at 0.83 Hz, 100° C. | | |
| G′, 15% (MPa) | 100 | 108 |
| Cure State | | |
| Delta Torque (dNm) | 100 | 104 |
| T90 (min) | 100 | 80 |
| Stiffness | | |
| RPA G′, 1% (MPa) | 100 | 103 |
| RPA G′ 50% (MPa) | 100 | 107 |
| MTE Properties | | |
| 300% Modulus (MPa) | 100 | 108 |
| Tensile strength (MPa) | 100 | 97 |
| Elongation at break (%) | 100 | 95 |
| Tear 100° C. (N) | 100 | 61 |
| RR Indicator | | |
| Rebound at 100° C. | 100 | 104 |
| Abrasion | | |
| DIN abrasion relative volume loss | 100 | 120 |
| Shore A Hardness | | |
| 23° C., 3S | 100 | 100 |

The tread base of the disclosed tire can employ a tread base rubber composition comprising of a mass balance BR between 25 and 45 phr with the remainder of the polymer matrix comprising of natural rubber. Moreover, the composition comprises of a carbon black derived from ELT pyrolysis oil between 40 and 50 phr; a biobased oil (such as soybean or rapeseed oil) within the range of 2 and 10 phr; a lignin-based antioxidant between the range of 0.1 and 2 phr; and a recycled zinc oxide between 1.5 and 3.5 phr.

### Example 4

Experimental Sample E4 is shown in Table 4. The Control C4 is a conventional wire coat compound. Sample E4 replaces the naphthenic oil with equal parts soybean oil; and replaces the synthetic polyisoprene with equal parts natural rubber. Moreover, conventional silica and carbon black fillers were replaced with silica from rice husk ash and carbon black derived from plant-based oil. The conventional antioxidant and zinc oxide were replaced with sustainably sourced versions, with all other ingredients being the same as Sample E4.

The rubber compounds were then cured and tested for various properties including, inter alia, rebound, stiffness, cure state, and stress/strain (MTE) properties, etc.

The basic formulations are shown in the following Table 4, which is presented in parts per 100 parts by weight of elastomer (phr). Results of the tests are also reported in Table 4, with the results of the Control rubber composition being normalized to values of 100 and the results for the Experimental Sample being related to the normalized value.

TABLE 4

Samples

| | Control | Experimental |
|---|---|---|
| | C4 | E4 |
| Synthetic Polyisoprene | 50 | 0 |
| Natural Rubber | 50 | 100 |
| Conventional silica | 4 | 0 |
| Rice husk ash silica | 0 | 4 |
| Conventional carbon black | 57 | 0 |
| Carbon black from plant-based oil | 0 | 57 |
| Conventional antioxidant | 1 | 0 |
| Lignin based antioxidant | 0 | 1 |
| Conventional ZnO | 8 | 0 |
| Recycled ZnO | 0 | 8 |
| Naphthenic oil | 2 | 0 |
| Soybean oil | 0 | 2 |
| Viscosity RPA at 0.83 Hz, 100° C. | | |
| G′ 15% (MPa) | 100 | 108 |
| Cure State | | |
| Delta Torque (dNm) | 100 | 104 |
| T90 (min) | 100 | 80 |
| Stiffness | | |
| RPA G′, 1% (MPa) | 100 | 103 |
| RPA G′ 50% (MPa) | 100 | 107 |
| MTE Properties | | |
| 300% Modulus (MPa) | 100 | 108 |
| Tensile strength (MPa) | 100 | 97 |
| Elongation at break (%) | 100 | 95 |
| Tear 100° C. (N) | 100 | 61 |
| Rebound | | |
| 23° C. (%) | 100 | 104 |
| 100° C. (%) | 100 | 104 |

The wirecoat of the disclosed tire can employ a rubber composition comprising of a natural rubber polymer matrix. Moreover, the composition comprises a filler system of a carbon black derived from plant-based oil between 40 and 70 phr and silica derived from rice husk ash at a level between 2 and 8 phr; a biobased oil (such as soybean or rapeseed oil) within the range of 0 and 5 phr; a lignin-based antioxidant between the range of 0.1 and 2 phr; and a recycled zinc oxide between 3 and 10 phr.

### Example 5

Experimental Sample E5 is shown in Tables 5A and 5B. The Control C5 is a conventional gum strip compound. Sample E5 replaces the synthetic rubber content with equal parts viscosity-controlled natural rubber; replaces the conventional silica with equal parts rice ash husk silica; replaces conventional carbon black with carbon black derived from plant-based oil; replaces the naphthenic oil with soybean oil; replaces the conventional zinc oxide and antioxidant with a recycled zinc oxide and a lignin-based antioxidant; and increases the cure package, with all other parts being equal to Control C5.

The rubber compounds were then cured and tested for various properties including, inter alia, stiffness, etc.

The basic formulations are shown in the following Table 5, which is presented in parts per 100 parts by weight of elastomer (phr). Results of the tests are also reported in Table 5, with the results of the Control rubber composition being normalized to values of 100 and the results for the Experimental Sample being related to the normalized value.

TABLE 5

Samples

| | Control | Experimental |
|---|---|---|
| | C5 | E5 |
| Synthetic | 49 | 0 |
| polyisoprene | | |
| Natural rubber A¹ | 51 | 0 |
| Natural rubber B² | 0 | 100 |
| Naphthenic oil | 4 | 0 |
| Soybean oil | 0 | 4 |
| Conventional carbon | 63 | 0 |
| black | | |
| Carbon black derived | 0 | 63 |
| from plant-based oil | | |
| Conventional silica | 5 | 0 |
| Rice husk ash silica | 0 | 5 |
| Conventional | 1 | 0 |
| antioxidant | | |
| Lignin based | 0 | 1 |
| antioxidant | | |
| Conventional ZnO | 8 | 0 |
| Recycled ZnO | 0 | 8 |
| Cure package | | Increase |
| Viscosity, RPA at 0.83 Hz, 100° C. | | |
| G′, 15% (MPa) | 100 | 85 |
| Cure State | | |
| Delta Torque (dNm) | 100 | 97 |
| T90 (min) | 100 | 82 |
| Stiffness | | |
| RPA G′, 1% (MPa) | 100 | 81 |
| RPA G′, 50% (MPa) | 100 | 87 |
| MTE Properties | | |
| 300% Modulus | 100 | 106 |
| (MPa) | | |
| Tensile strength | 100 | 105 |
| (MPa) | | |
| Elongation at break | 100 | 98 |
| (%) | | |
| DeMattia Pierced | 100 | 98 |
| Rate (min/nm) | | |
| Rebound | | |
| 23° C. (%) | 100 | 105 |
| 100° C. (%) | 100 | 107 |

¹TSR 10 Natural rubber
²TSR5-CV Natural rubber

The gumstrip of the disclosed tire can employ a rubber composition comprising of a natural rubber polymer matrix. Moreover, the composition comprises a filler system of a carbon black derived from plant-based oil between 50 and 75 phr and silica derived from rice husk ash at a level between 2 and 10 phr; a biobased oil (such as soybean or rapeseed oil) within the range of 0 and 6 phr; a lignin-based antioxidant between the range of 0.1 and 2 phr; and a recycled zinc oxide between 5 and 12 phr.

### Example 6

Experimental Samples E6 is shown in Table 6. The Control C6 is a conventional inline overlay compound. Sample E6 slightly adjusts the polymer levels, while replacing ESBR with a mass balance SBR; replaces the naphthenic oil of Control C6 with soybean oil; replaces the filler system of conventional silica and carbon black with silica derived from rice husk ash and carbon black derived from plant-oil; replaces the conventional zinc oxide and antioxidant with a recycled zinc oxide and a lignin-based antioxidant; and adjusts the cure package, with all other ingredients being the same.

The rubber compounds were then cured and tested for various properties including, inter alia, rebound, stiffness, cure state, and MTE properties, etc.

The basic formulations are shown in the following Table 6, which is presented in parts per 100 parts by weight of elastomer (phr). Results of the tests are also reported in Table 6, with the results of the Control rubber composition being normalized to values of 100 and the results for the Experimental Sample being related to the normalized value.

TABLE 6

Samples

| | Reference | Experimental |
|---|---|---|
| | C6 | E6 |
| Natural rubber | 80 | 85 |
| ESBR | 20 | 0 |
| Mass balanced SBR | 0 | 15 |
| Conventional silica | 3 | 0 |
| Rice husk ash silica | 0 | 3 |
| Conventional carbon black | 46 | 0 |
| Carbon black from plant-based oil | 0 | 46 |
| Conventional antioxidant | 1 | 0 |
| Lignin based antioxidant | 0 | 1 |
| Conventional ZnO | 5 | 0 |
| Recycled ZnO | 0 | 5 |
| Naphthenic oil | 6.5 | 0 |
| Soybean oil | 0 | 6.5 |
| Cure package | | Increase |
| Viscosity, RPA at 0.83 Hz, 100° C. | | |
| G′, 15% (MPa) | 100 | 105 |
| Cure State | | |
| Delta Torque (dNm) | 100 | 84 |
| T90 (min) | 100 | 71 |
| Stiffness | | |
| RPA G′, 1% (MPa) | 100 | 88 |
| RPA G′ 50% (MPa) | 100 | 94 |
| MTE Properties | | |
| 300% Modulus (MPa) | 100 | 100 |
| Tensile strength (MPa) | 100 | 91 |
| Elongation at break (%) | 100 | 92 |
| Tear 100° C. (N) | 100 | 84 |
| Rebound | | |
| 100° C. (%) | 100 | 105 |

The overlay of the disclosed tire can employ a rubber composition comprising of a blend of natural rubber and mass balance SBR. Moreover, the composition comprises a filler system of a carbon black derived from plant-based oil between 35 and 50 phr and silica derived from rice husk ash at a level between 1 and 8 phr; a biobased oil (such as soybean or rapeseed oil) within the range of 2 and 10 phr; a lignin-based antioxidant between the range of 0.1 and 2 phr; and a recycled zinc oxide between 1 and 8 phr.

### Example 7

Experimental Samples E7 is shown in Table 7. The Control C7 is a conventional plycoat compound. Sample E7 is comprised of a mass balance SBR/natural rubber blend. Sample E7 replaces the naphthenic oil of Control C7 with soybean oil; replaces the conventional carbon black with a higher level of carbon black derived from ELT pyrolysis oil; increases the cure package; replaces the conventional silica with rice ash husk silica; and replaces the conventional zinc oxide and antioxidant with a recycled zinc oxide and lignin-based antioxidant, with all other ingredients being the same.

The rubber compounds were then cured and tested for various properties including, inter alia, stiffness, etc.

The basic formulations are shown in the following Table 7, which is presented in parts per 100 parts by weight of elastomer (phr). Results of the tests are also reported in Table 7, with the results of the Control rubber composition being normalized to values of 100 and the results for the Experimental Sample being related to the normalized value.

TABLE 7

Samples

| | Control | Experimental |
|---|---|---|
| | C7 | E7 |
| Natural rubber | 80 | 80 |
| ESBR | 20 | 0 |
| Mass balance SBR | 0 | 20 |
| Conventional carbon black | 35 | 0 |
| Carbon black from ELT pyrolysis oil | 0 | 39 |
| Naphthenic oil | 7 | 0 |
| Soybean oil | 0 | 7 |
| Conventional silica | 3 | 0 |
| Rice husk ash silica | 0 | 3 |
| Conventional antioxidant | 1 | 0 |
| Lignin based antioxidant | 0 | 1 |
| Conventional ZnO | 2 | 0 |
| Recycled ZnO | 0 | 2 |
| Cure package | | increase |
| Viscosity RPA at 0.83 Hz, 100° C. | | |
| G′, 15% (MPa) | 100 | 112 |
| Cure State | | |
| Delta Torque (dNm) | 100 | 110 |
| T90 (min) | 100 | 77 |
| Stiffness | | |
| RPA G′, 1% (MPa) | 100 | 97 |
| RPA G′ 50% (MPa) | 100 | 112 |
| MTE Properties | | |
| 300% Modulus (MPa) | 100 | 113 |
| Tensile strength (MPa) | 100 | 101 |
| Elongation at break (%) | 100 | 95 |
| Tear 100° C. (N) | 100 | 68 |
| Rebound | | |
| 100° C. (%) | 100 | 107 |

The plycoat of the disclosed tire can employ a rubber composition comprising of a blend of natural rubber and mass balance SBR. Moreover, the composition comprises a filler system of a carbon black derived from plant-based oil between 30 and 50 phr and silica derived from rice husk ash at a level between 1 and 5 phr; a biobased oil (such as soybean or rapeseed oil) within the range of 3 and 10 phr; a lignin-based antioxidant between the range of 0.1 and 2 phr; and a recycled zinc oxide between 1 and 4 phr.

### Example 8

Experimental Sample E8 is shown in Table 8. The Controls C8 is for a conventional sidewall compound. Polymer levels were adjusted in experimental Sample E8 to increase natural rubber content; the conventional polybutadiene was replaced with a mass balance BR. Sample E8 further replaces the naphthenic oil of Controls C8 with soybean oil and increases the cure package. It also replaces the petroleum derived hydrocarbon for a bio-based resin, the conventional zinc oxide with a recycled zinc oxide, and the conventional carbon black with sustainably derived carbon blacks. All other ingredients remain the same as Control C8.

The rubber compounds were then cured and tested for various properties including, inter alia, stiffness, weathering, tear and MTE, and rolling resistance properties, etc.

The basic formulations are shown in the following Table 8, which is presented in parts per 100 parts by weight of elastomer (phr). Results of the tests are also reported in Table 8, with the results of the Control rubber composition being normalized to values of 100 and the results for the Experimental Sample being related to the normalized value.

TABLE 8

Samples

| | Control | Experimental |
|---|---|---|
| | C8 | E8 |
| Polybutadiene | 65 | 0 |
| Mass balance BR | 0 | 50 |
| Natural Rubber | 35 | 50 |
| Naphthenic oil | 15 | 0 |
| Soybean oil | 0 | 15 |
| Conventional carbon black | 51 | 0 |
| Sustainably sourced carbon black A¹ | 0 | 40 |
| Sustainably sourced carbon black B² | 0 | 15 |
| Resin A³ | 3.5 | 0 |
| Resin B⁴ | 0 | 3.5 |
| Conventional ZnO | 2 | 0 |
| Recycled ZnO | 0 | 2 |
| AO/AOz Package | 6.25 | 6.25 |
| Cure package | | Increase |
| Viscosity RPA at 0.83 Hz, 100° C. | | |
| G′ 15% (MPa) | 100 | 89 |
| Cure State | | |
| Delta Torque (dNm) | 100 | 84 |
| T90 (min) | 100 | 123 |
| Stiffness | | |
| RPA G′, 1% (MPa) | 100 | 81 |
| RPA G′, 50% (MPa) | 100 | 79 |
| MTE Properties | | |
| 300% Modulus (MPa) | 100 | 83 |
| Tensile strength (MPa) | 100 | 106 |
| Elongation at break (%) | 100 | 108 |
| Tear 100° C. (N) | 100 | 93 |
| Rebound | | |
| 100° C. Rebound (%) | 100 | 112 |

¹Carbon black derived from ELT pyrolysis oil
²Carbon black derived from methane pyrolysis
³Phenol formaldehyde resin
⁴Bio-based gum resin

A tire of the disclosed invention may employ sidewalls formed from a sidewall rubber composition comprising in a non-limiting example from 25 phr to 75 phr of a mass-balanced polybutadiene. Moreover, the sidewall rubber composition comprises from 25 phr to 75 phr of natural rubber. As a filler, the sidewall rubber composition comprises from 10 phr to 20 phr of a methane pyrolysis-based carbon black and from 20 phr to 60 phr carbon black from ELT pyrolysis oil. In addition, the rubber composition may comprise from 10 phr to 20 phr of a vegetable triglyceride oil such as soybean oil, from 1 to 3 phr of recycled zinc oxide, and from 2 phr to 7 phr of a bio-based gum resin.

### Example 9

Experimental Sample E9 is shown in Table 9. The Control C9 is for a conventional inner liner compound. Sample E9 replaces conventional carbon black with a carbon black derived from methane pyrolysis, the naphthenic oil of Control C9 with soybean oil, the conventional ZnO with a recycled ZnO, and further increases the cure package, with all other ingredients being the same.

The rubber compounds were then cured and tested for various properties including, inter alia, stress and tear (MTE), etc.

The basic formulations are shown in the following Table 9, which is presented in parts per 100 parts by weight of elastomer (phr). Results of the tests are also reported in Table 9, with the results of the Control rubber composition being normalized to values of 100 and the results for the Experimental Sample being related to the normalized value.

TABLE 9

| | Samples | |
|---|---|---|
| | Control | Experimental |
| | C9 | E9 |
| Conventional carbon black | 70 | 0 |
| Carbon black from methane pyrolysis | 0 | 70 |
| Naphthenic oil | 6 | 0 |
| Soybean oil | 0 | 6 |
| Conventional ZnO | 1 | 0 |
| Recycled ZnO | 0 | 1 |
| Cure package | | increase |
| Viscosity RPA at 0.83 Hz, 100° C. | | |
| G′, 15% (MPa) | 100 | 100 |
| Cure State | | |
| Delta Torque (dNm) | 100 | 61 |
| T90 (min) | 100 | 70 |
| Stiffness | | |
| RPA G′ 1% (MPa) | 100 | 68 |
| RPA G′ 50% (MPa) | 100 | 71 |
| MTE Properties | | |
| 300% Modulus (MPa) | 100 | 45 |
| Tensile strength (MPa) | 100 | 69 |
| Elongation at break (%) | 100 | 114 |
| Tear 100° C. (N) | 100 | 81 |
| Rebound | | |
| Rebound at 23° C. (%) | 100 | 93 |
| Rebound at 100° C. (%) | 100 | 95 |
| Air Permeability | | |
| MOCON Oxygen Diffusion Permeation* | 100 | 58 |
| (cm³-mm)/(m²-d) | | |

The inner liner of the disclosed invention may, in one embodiment, be formed from an inner liner rubber composition comprising of 0 phr to 10 phr of reclaimed butyl rubber. Moreover, this rubber composition comprises from 2 phr to 10 phr of a vegetable oil, such as soybean or rapeseed oil, and may include other bio-based ingredients such as 1 phr to 5 phr of (bio-based) fatty acid, recycled ZnO from 0.1 to 2 phr, or bio-derived carbon black in an amount of between 1 phr to about 200 phr.

### Example 10

Experimental Samples E10 and E11 are shown in Table 10. The Control C10 is for a conventional chafer/toeguard compound. Samples E10 and E11 have similar formulations, but E10 was used as the chafer, while E11 was used as the toeguard. Samples E10/E11 replaces the naphthenic oil of Control C10 with soybean oil, and further increases the cure package. Samples E10/E11 also replaces the petroleum derived hydrocarbon resin for a bio-based resin, the conventional carbon black with sustainably sourced carbon blacks, and the conventional ZnO with recycled ZnO. It also adjusts the polymer levels to comprise a greater amount natural rubber, replacing the conventional polybutadiene and SBR with mass balance versions, with all other ingredients being the same as C10.

The rubber compounds were then cured and tested for various properties including, inter alia, cure, tear, etc.

The basic formulations are shown in the following Table 10, which is presented in parts per 100 parts by weight of elastomer (phr). Results of the tests are also reported in Table 10, with the results of the Control rubber composition being normalized to values of 100 and the results for the Experimental Sample being related to the normalized value.

TABLE 10

| | Samples | | |
|---|---|---|---|
| | Reference | | Experimental |
| | C10 | E10 | E11 |
| Polybutadiene | 45 | 0 | 0 |
| Mass balance BR | 0 | 30 | 30 |
| ESBR | 30 | 0 | 0 |
| Mass balance SBR | 0 | 30 | 30 |
| Synthetic polyisoprene | 25 | 0 | 0 |
| Natural rubber | 0 | 40 | 40 |
| Conventional carbon black | 81 | 0 | 0 |
| Carbon black from plant-based | 0 | 61 | 61 |
| oil | | | |
| Carbon black from ELT | 0 | 22 | 22 |
| pyrolysis oil | | | |
| Naphthenic oil | 16 | 0 | 0 |
| Soybean oil | 0 | 16 | 16 |
| Conventional ZnO | 2 | 0 | 0 |
| Recycled ZnO | 0 | 3 | 3 |
| Resin A¹ | 2 | 0 | 0 |
| Resin B² | 0 | 3 | 3 |
| Cure package | | increase | increase |
| Viscosity RPA at 0.83 Hz, 100° C. | | | |
| G′, 15% (MPa) | 100 | 102 | 95 |
| Cure State | | | |
| Delta Torque (dNm) | 100 | 100 | 93 |
| T90 (min) | 100 | 91 | 105 |
| Stiffness | | | |
| RPA G′, 1% (MPa) | 100 | 94 | 85 |
| RPA G′ 50% (MPa) | 100 | 82 | 95 |
| MTE Properties | | | |
| 300% Modulus (MPa) | 100 | 103 | 103 |
| Tensile strength (MPa) | 100 | 102 | 93 |
| Elongation at break (%) | 100 | 103 | 97 |
| Tear SS Ave Load 100° C. | 100 | 110 | 92 |
| RR Indicator | | | |
| Rebound at 23° C. | 100 | 108 | 110 |
| Rebound at 100° C. | 100 | 104 | 107 |
| Compression Set | | | |
| % set, 22 h hrs, 70° C. | 100 | 54 | 100 |

¹Phenol formaldehyde resin
²Tall oil resin

The tire of the disclosed invention can employ a toeguard/chafer formed from a chafer rubber composition comprising from 20 phr to 40 phr of mass-balanced polybutadiene rubber, from 20 phr to 80 phr of natural rubber, and optionally up to 40 phr of ESBR. Moreover, the rubber composition may further comprise optionally from 1 phr to 20 phr of a vegetable oil, 15 to 100 phr carbon black sourced from sustainably derived feedstocks, recycled ZnO from 1 to 5 phr, and from 0.1 phr to 5 phr of resin.

While not shown herein, further tire components such as base tread(s), chimney(s), wedge, cushions or rubber strips may also be present and may have also rubber compositions comprising one or more of the recycled and/or bio-based ingredients disclosed herein. In general, specific examples of materials mentioned in one embodiment can also be used as materials in another embodiment disclosed herein.

### Example 11

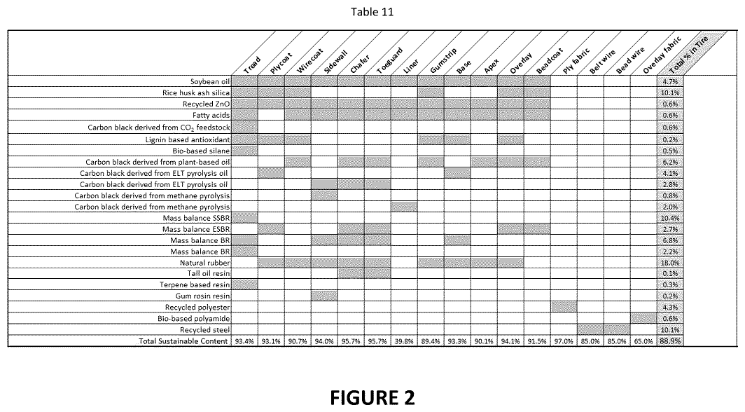

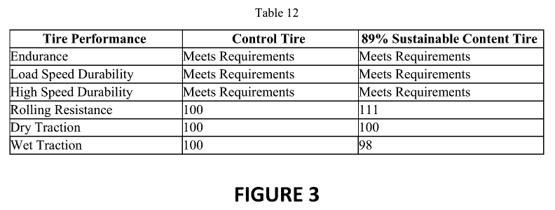

Example 11 is shown in FIGS. 2 and 3. FIG. 2 shows a summary of the combination of compounds outlined in examples 1 through 10 to form a tire with competitive performance. Example 11 includes the reinforcement materials, including polyamide, steel, and polyester. The breakdown of sustainable materials within each component is described in Table 11. The components range in sustainable content from 39.8% to 97% by weight.

The performance of the aforementioned tire was tested. FIG. 3 reports the tire results for endurance, high speed durability, load speed durability, rolling resistance, and trailer traction. The results of the conventional tire are normalized to values of 100 and the results for Example 11 are related to the normalized value.

The tire with 89% by weight sustainable content matched or outperformed the control tire in all performance criteria, within testing variation. A significant improvement in rolling resistance performance was achieved with the incorporation of sustainable materials, as described in Examples 1 through 10.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A sustainable tire formed from tire parts comprising at least one each of a tread, plycoat, wirecoat, sidewall, chafer, toeguard, gumstrip base, apex, overlay and beadcoat:
wherein the tire parts are each formed from a diene rubber composition comprising a mass-balance synthetic polymer;
wherein the diene rubber is present at greater than 35% by weight in the tire; and
wherein the tire is formed from greater than about 85% by weight of content made from processes or technologies that reduce carbon emissions and/or resource consumption, and/or recycled, renewable, bio-based, bio-derived, and mass balance raw materials; wherein the bio-based content of the tire is verifiable, and wherein radiocarbon ¹⁴C dating according to ASTM method D6866 shows the tire to have a bio-based content of greater than 85%.

2. The tire of claim 1, wherein each tire component is further formed from or coated with a rubber composition comprising at least one material selected from a group consisting of: natural rubbers; fatty acids; bio-based resins such as terpene and/or rosin-based resins; bio-based coupling agents and/or systems; vegetable triglyceride oil; fillers including carbon black derived from bio-derived, bio-recycled, recycled (circular) feedstocks, or produced from technologies that reduce carbon emissions/conserve resources and/or rice husk ash silica; recycled materials such as zinc oxide, steel and/or polyester; and lignin-based antiozonant or antioxidant.

3. The tire of claim 1 further comprising at least one reinforcement characterized by greater than or equal to 65 percent by weight recycled and/or renewable content.

4. The tire of claim 1, wherein the liner is characterized by greater than or equal to 35 percent by weight sustainable material content;
the belt wire being characterized by greater than or equal to 85 percent by weight sustainable material content;
the bead wire being characterized by greater than or equal to 85 percent by weight sustainable material content;
the gum strip being characterized by greater than or equal to 89 percent by weight sustainable material content;
the wire coat characterized by greater than or equal to 90 percent by weight sustainable material content;
the apex being characterized by greater than or equal to 90 percent by weight sustainable material content;
the bead coat being characterized by greater than or equal to 91 percent by weight sustainable material content;
the base being characterized by greater than or equal to 93 percent by weight sustainable material content;
the plycoat being characterized by greater than or equal to 93 percent by weight sustainable material content;
the tread characterized by greater than or equal to 93 percent by weight sustainable material content;
the sidewall being characterized by greater than or equal to 93 percent by weight sustainable material content;
the overlay being characterized by greater than or equal to 94 percent by weight sustainable material content;
the toeguard being characterized by greater than or equal to 95 percent by weight sustainable material content; and
the chafer being characterized by greater than or equal to 95 percent by weight sustainable material content.

5. The pneumatic tire of claim 2, wherein the tire components are selected from the group comprising: bead coat; apex; tread base; wire coat; gum strip; inline overlay; plycoat; sidewall; inner liner; and chafer or toe guard.

6. The tire of claim 1, wherein at least two of the tire parts are formed from sustainable material to provide a percent weight content in the tire;
the at least one liner providing greater than or equal to 2.0% of the overall sustainable material content in the tire;
the at least one gum strip providing greater than or equal to 1.0% of the overall sustainable material content in the tire;
the at least one wire coat providing greater than or equal to 5.5% of the overall sustainable material content in the tire;
the at least one apex providing greater than or equal to 2.0% of the overall sustainable material content in the tire;
the at least one bead coat providing greater than or equal to 0.3% of the overall sustainable material content in the tire;
the at least one base providing greater than or equal to 4.0% of the overall sustainable material content in the tire;
the at least one plycoat providing greater than or equal to 10.0% of the overall sustainable material content in the tire;
the at least one tread providing greater than or equal to 28.0% of the overall sustainable material content in the tire;
the at least one sidewall providing greater than or equal to 9.0% of the overall sustainable material content in the tire;
the at least one overlay providing greater than or equal to 1.75% of the overall sustainable material content in the tire;
the at least one toeguard providing greater than or equal to 3.0% of the overall sustainable material content in the tire;
the at least one chafer providing greater than or equal to 3.25% of the overall sustainable material content in the tire;
the at least one polyester providing greater than or equal to 4.0% of the overall sustainable material content in the tire;
the at least one polyamide providing greater than or equal to 0.6% of the overall sustainable material content in the tire; and
a combination of the above.

7. The tire of claim 6 further comprising:
a belt wire providing greater than or equal to 5.0% weight of the overall sustainable material content in the tire; and
a bead wire providing greater than or equal to 4.5% weight of the overall sustainable material content in the tire.

8. The tire of claim 1 further comprising:
at least one polyester providing greater than or equal to 4.0% weight of the overall sustainable material content in the tire; and at least one polyamide providing greater than or equal to 0.6% weight of the overall sustainable material content in the tire.

9. The tire of claim 1, wherein the beadcoat coats two spaced apart beads, wherein the beads and the sidewall extend radially from and connect a tread to the beads, the tire being formed from rubber compositions comprising at least one of a mass-balanced SBR and/or polybutadiene in the tread, the sidewall and the bead coat.

10. The tire of claim 9 further comprising:
at least a mass-balanced SSBR in the tread;
at least a mass-balanced polybutadiene in the sidewall; and
at least a mass-balanced ESBR in the beadcoat.

11. The tire of claim 10 further comprising:
a carbon black derived from a CO₂ feedstock in the tread;
a carbon black derived from end-of-life (ELT) pyrolysis oil in the sidewall;
a carbon black derived from methane pyrolysis in the sidewall; and
a carbon black derived from plant-based oil in the beadcoat, wherein the diene rubber composition comprising a mass-balance synthetic polymer is void of isoprene-butadiene rubbers.

12. The tire of claim 4, wherein the bead coat is comprised of emulsion styrene-butadiene rubber, soybean oil, and carbon black from plant based oil, and wherein the bead coat is characterized by having a verifiable bio-based content by radiocarbon ¹⁴C dating according to ASTM method D6866 of than greater than or equal to 91 percent.

13. The tire of claim 4, wherein the apex is comprised of natural rubber and carbon black from plant based oil, and wherein the apex is characterized by having a verifiable bio-based content by radiocarbon ¹⁴C dating according to ASTM method D6866 of than greater than or equal to 90 percent.

14. The tire of claim 4, wherein the tread is comprised of polybutadiene rubber, natural rubber, and carbon black from ELT pyrolysis oil, and wherein the tread is characterized by having a verifiable bio-based content by radiocarbon ¹⁴C dating according to ASTM method D6866 of than greater than or equal to 93 percent.

15. The tire of claim 4, wherein the sidewall is comprised of polybutadiene rubber, natural rubber, soybean oil, and carbon black from ELT pyrolysis oil, and wherein the sidewall is characterized by having a verifiable bio-based content by radiocarbon ¹⁴C dating according to ASTM method D6866 of than greater than or equal to 93 percent.

16. The tire of claim 4, wherein the bead coat is comprised of emulsion styrene-butadiene rubber, soybean oil, and carbon black from plant based oil, wherein the bead coat is characterized by having a verifiable bio-based content by radiocarbon 14C dating according to ASTM method D6866 of than greater than or equal to 91 percent, wherein the apex is comprised of natural rubber and carbon black from plant based oil, wherein the apex is characterized by having a verifiable bio-based content by radiocarbon ¹⁴C dating according to ASTM method D6866 of than greater than or equal to 90 percent, wherein the tread is comprised of polybutadiene rubber, natural rubber, and carbon black from ELT pyrolysis oil, wherein the tread is characterized by having a verifiable bio-based content by radiocarbon ¹⁴C dating according to ASTM method D6866 of than greater than or equal to 93 percent, wherein the sidewall is comprised of polybutadiene rubber, natural rubber, soybean oil, and carbon black from ELT pyrolysis oil, and wherein the sidewall is characterized by having a verifiable bio-based content by radiocarbon 14C dating according to ASTM method D6866 of than greater than or equal to 93 percent.

17. A pneumatic tire which is comprised of a supporting carcass with an outer circumferential tread, two spaced beads, at least one ply extending from bead to bead, and sidewalls extending radially from and connecting said tread to said beads, wherein said circumferential tread is adapted to be ground-contacting, wherein said tire is comprised of bio-renewable organic materials, wherein the bio-based content of the organic materials is verifiable, and wherein radiocarbon ¹⁴C dating according to ASTM method D6866 shows the level of bio-based content of the organic materials to be at least 40%.

18. The pneumatic tire of claim 17 wherein said tire has an RFID tag affixed thereto, wherein the RFID tag designates the level of bio-renewable organic materials in the tire.

19. The pneumatic tire of claim 18 wherein the tire includes an innerliner which is disposed inwardly from the supporting carcass of the tire and wherein the RFID tag is affixed to innerliner at a position in the sidewall area of the tire.

20. A method of separating used or flawed tires in a recycle stream based upon their content of bio-renewable organic materials which comprises passing a stream of tires containing the tires of claim 19 through a separator system which is comprised of a tire fed line, an interrogator, a separator, a diverter, and at least two recycle conveyance lines, wherein the tires are separated based upon the bio-based content of the organic materials in the tires.
